(19) United States
(12) Patent Application Publication
(10) Pub. No.: US 2024/0356113 A1
(43) Pub. Date: Oct. 24, 2024

(54) FIBER BATTERY

(71) Applicant: The Johns Hopkins University, Baltimore, MD (US)

(72) Inventors: Konstantinos Gerasopoulos, Gambrills, MD (US); Jason E. Tiffany, Columbia, MD (US)

(73) Assignee: The Johns Hopkins University, Baltimore, MD (US)

(21) Appl. No.: 18/642,938

(22) Filed: Apr. 23, 2024

Related U.S. Application Data
(60) Provisional application No. 63/497,840, filed on Apr. 24, 2023.

(51) Int. Cl. H01M 50/105; H01M 4/04; H01M 4/66; H01M 10/04; H01M 50/403; H01M 50/411

(52) U.S. Cl. CPC H01M 50/105; H01M 4/0404; H01M 4/661; H01M 10/0481; H01M 50/403; H01M 50/411

(57) ABSTRACT

Disclosed herein are systems and methods of making flexible fiber batteries. The fiber batteries are amenable for deployment in textiles, for example, wearable fabrics. The fiber battery can be used to provide power to wearable electronic devices. The fiber battery disclosed herein can be a sub-millimeter (mm) diameter active battery stack having a coating that provides a fiber having a diameter of up to 1 mm that can be woven, stitched, knitted, or otherwise incorporated into a fabric.

### CROSS-REFERENCE TO RELATED APPLICATIONS

The present application claims priority to and filing benefit of U.S. Provisional Patent Application No. 63/497,840, filed on Apr. 24, 2023, which is incorporated herein by reference in its entirety.

### BACKGROUND

Energy harvesting, energy consumption, and energy storage are a ubiquitous part of present day and future society. As energy consumption devices evolve, so does the need for high capacity energy storage in unique applications.

### SUMMARY

There exists a need for high-capacity, flexible, safe, and efficient power sources, e.g., batteries, as wearable electronic and medical devices become more common.

In some embodiments of the present disclosure, described herein is fiber battery that includes an anode film, a cathode film, a separator film disposed between the anode film and the cathode film (the anode film, the cathode film, and the separator film provide a fiber battery stack having a width of up to 1 millimeter (mm)), and a coating configured to cover the fiber battery stack. In some embodiments, the anode film and the cathode film can include a current collector, e.g., the anode film current collector can be copper and the cathode film current collector can be aluminum. In some embodiments, the current collector comprises an elastic substrate or a plastic substrate. In some embodiments, the fiber battery can be a battery stack film configured to be cut to provide the fiber battery stack. In some embodiments, the coating is amenable to use in a fabric.

In other embodiments of the present disclosure, a method of making a fiber battery includes forming an anode film, forming a separator film, forming a cathode film, laminating the anode film, the separator film, and the cathode film (e.g., to provide a battery stack film), removing a linear portion of the battery stack film to provide a battery stack fiber (e.g., by laser cutting a portion having a width of up to 1 mm), and coating the battery stack fiber to provide the fiber battery (e.g., by immersing the battery stack fiber in a liquid coating solution and curing the liquid coating solution). In some embodiments, the method includes immersing the battery stack fiber in an electrolyte solution before the coating (e.g., immersing the battery stack fiber in an electrolyte solution that is immiscible with the coating solution). In some embodiments, the laminating, the removing, and the coating are performed in a roll-to-roll process In some embodiments, forming the separator film comprises extruding a polymer film.

In further embodiments of the present disclosure, a method of making a fiber battery includes forming an anode film, forming a solid electrolyte film, forming a cathode film, laminating the solid electrolyte film and the cathode film to provide an electrolytic cathode film, laminating the anode film and the electrolytic cathode film to provide a battery stack film, removing a linear portion of the battery stack film to provide a battery stack fiber (e.g., by laser cutting a portion of the battery stack film having a width of up to 1 mm), and coating the battery stack fiber to provide the fiber battery (e.g., by immersing the battery stack fiber in a liquid coating solution and curing the liquid coating solution). In some embodiments, forming the solid electrolyte film can include mixing a solid electrolyte material with an anode material, a cathode material, or an anode material and a cathode material prior to laminating. In some embodiments, the laminating, the removing, and the coating are performed in a roll-to-roll process.

In further embodiments of the present disclosure, a method of providing a fiber battery includes a roll-to-roll process including coating a first current collector with a first electrode material (e.g., coating a copper film with an anodic electrode material to provide an anode film), coating a second current collector with a second electrode material (e.g., coating an aluminum film with a cathodic electrode material to provide a cathode film), extruding a separator film, laminating the first current collector having the first electrode material, the separator film, and the second current collector having the second electrode material to provide a battery stack film (e.g., feeding the first current collector having the first electrode material, the separator film, and the second current collector having the second electrode material through a thermal roller press), laser cutting a portion of the battery stack film to provide a battery stack fiber, and encapsulating the battery stack fiber (e.g., immersing the battery stack fiber in a liquid polymer solution and curing the liquid polymer solution to provide a solid polymer coating).

In some embodiments, the laser cutting includes activating a laser, aiming the laser at the battery stack film, illuminating the battery stack film on a first side of the battery stack film with a white light source, observing the laser cutting operation with a camera disposed on a side of the battery stack film opposite the white light source, and controlling the laser cutting operation with a control unit configured to interpret data received from the camera, wherein the controlling the laser cutting comprises maintaining cutting a portion of the battery stack film having a width of up to 1 mm

In further embodiments of the present disclosure, a roll-to-roll fiber battery fabrication fixture includes a feed roller configured to supply a battery stack component film (e.g., the battery stack component film includes an anode film, a separator film, and a cathode film), a laminating roller configured to press and thermally laminate the battery stack component films into a battery stack film, a tensioning roller configured to reduce film vibration during roll-to-roll processing, a laser cutter configured to remove a portion of the battery stack film to provide a battery stack fiber, a camera configured to observe the laser cutter and generate camera information, a back light configured to provide reference lighting for the camera, a control unit configured to receive the camera information and adjust the laser cutter to maintain a consistent width of the portion of the battery stack film being removed, and a rewind roller configured to collect the battery stack fiber after roll-to-roll fabrication. In some embodiments, the roll-to-roll fiber battery fabrication fixture includes a roll-to-roll coating fixture, a battery stack fiber rewind roller, a plurality of laser cutters, a plurality of battery stack fiber rewind rollers, and a coating station configured to immerse the battery stack fiber in a polymer solution and cure the polymer solution to provide a fiber coating.

Covered embodiments are defined by the claims, not this summary. This summary is a high-level overview of various aspects of the embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

### BRIEF DESCRIPTION OF THE DRAWINGS

The accompanying drawings are incorporated herein and form a part of the specification.

FIG. 1 shows a schematic of a method and a product made by the method according to some embodiments of the present disclosure.

FIG. 2 shows a schematic of a method and a product made by the method according to some embodiments of the present disclosure.

FIG. 3 shows a schematic of a method and a product made by the method according to some embodiments of the present disclosure.

FIG. 4 shows a schematic of a product according to some embodiments of the present disclosure.

FIGS. 5A-5D show methods and products for providing a polymer separator according to some embodiments of the present disclosure.

FIGS. 6A-6D show properties of a polymer separator according to some embodiments of the present disclosure.

FIGS. 7A-7D show a roll-to-roll laser cutting system according to some embodiments of the present disclosure.

FIGS. 8A-8B show cross sections of a fiber battery according to some embodiments of the present disclosure.

FIGS. 9A-9D show electrochemical testing of a fiber battery according to some embodiments of the present disclosure.

FIG. 10 shows a coating system according to some embodiments of the present disclosure.

FIG. 11 shows a fiber battery configuration according to some embodiments of the present disclosure.

FIG. 12 shows a fiber battery configuration according to some embodiments of the present disclosure.

FIG. 13 shows a fiber battery configuration according to some embodiments of the present disclosure.

FIGS. 14A-14D show cross sections and electrochemical testing of a fiber battery according to some embodiments of the present disclosure.

FIG. 15 is a flowchart showing a method according to some embodiments of the present disclosure.

FIG. 16 is a flowchart showing a method according to some embodiments of the present disclosure.

FIG. 17 is a flowchart showing a method according to some embodiments of the present disclosure.

In the drawings, like reference numbers generally indicate identical or similar elements.

### DETAILED DESCRIPTION

As used herein, the meaning of “a,” “an,” and “the” includes singular and plural references unless the context clearly dictates otherwise.

All ranges disclosed herein are to be understood to encompass any and all endpoints as well as any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

The term “and/or” when used in a list of two or more items, means that any one of the listed items can be employed by itself or in combination with any one or more of the listed items. For example, the expression “A and/or B” is intended to mean either or both of A and B, i.e., A alone, B alone, or A and B in combination. The expression “A, B and/or C” is intended to mean A alone, B alone, C alone, A and B in combination, A and C in combination, B and C in combination or A, B, and C in combination.

Embodiments of the present disclosure are directed to a fiber battery amenable for deployment in textiles, for example, wearable fabrics. The fiber battery can be used to provide power to wearable electronic devices. The fiber battery disclosed herein can be a sub-millimeter (mm) diameter active battery stack having a coating that provides a fiber having a diameter of up to 1 mm that can be woven, stitched, knitted, or otherwise incorporated into a fabric. The present disclosure is also directed to a method of manufacturing the fiber battery and apparatus employed therein.

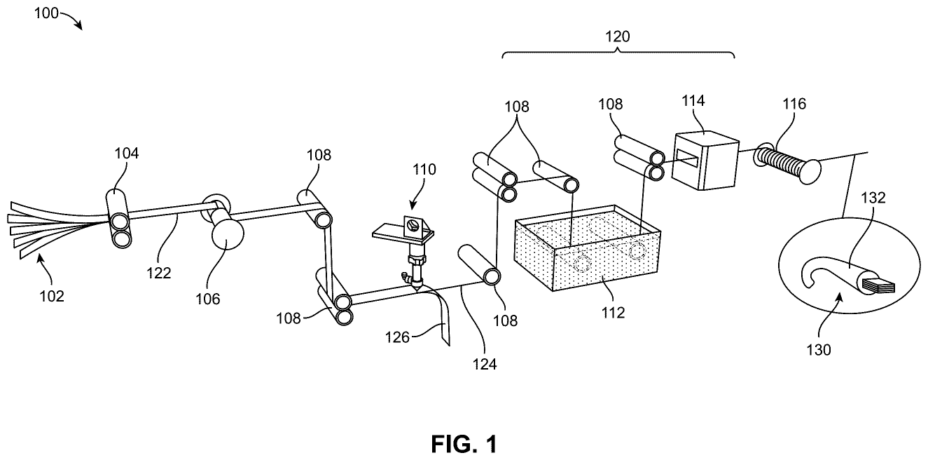

FIG. 1 shows a schematic of a method and a product made by the method according to some embodiments of the present disclosure. For example, FIG. 1 is a schematic showing a fabrication line 100 according to some embodiments. In some aspects, fabrication line 100 comprises battery material films 102, a laminating roller 104, a first rewind roller 106, tensioning rollers 108, a laser cutter 110, a bath 112, a curing device 114, and a second rewind roller 116. In some aspects, fabrication line 100 comprises coating stations 120 comprising bath 112 and curing device 114.

In some aspects, fabrication line 100 processes a plurality of battery material films 102 that are fed into a laminating roller 104 to provide a battery stack film 122 and can be wound onto rewind roller 106.

In some aspects, tensioning rollers 108 can be used to eliminate slack in battery stack film 122 to maintain a high level of control in a fabrication process.

In some aspects, laser cutter 110 can remove a portion of battery stack film 122 having a width of up to about 1 mm that is a battery stack fiber 124. A remainder 126 of battery stack film 122 can be rewound for later fabrication, or can be fed to another laser cutter 110 deployed in an adjacent or neighboring fabrication line (not shown). In some aspects, fabrication line 100 can include a plurality of laser cutters 110, a plurality of rewind rollers 106/116, and/or a plurality of coating stations 120.

In some aspects, battery stack fiber 124 can be fed into coating station 120 including bath 112 and curing device 114 to produce a fiber battery 130. In some aspects, fiber battery 130 can have a polymer coating 132 that can be wound onto second rewind roller 116.

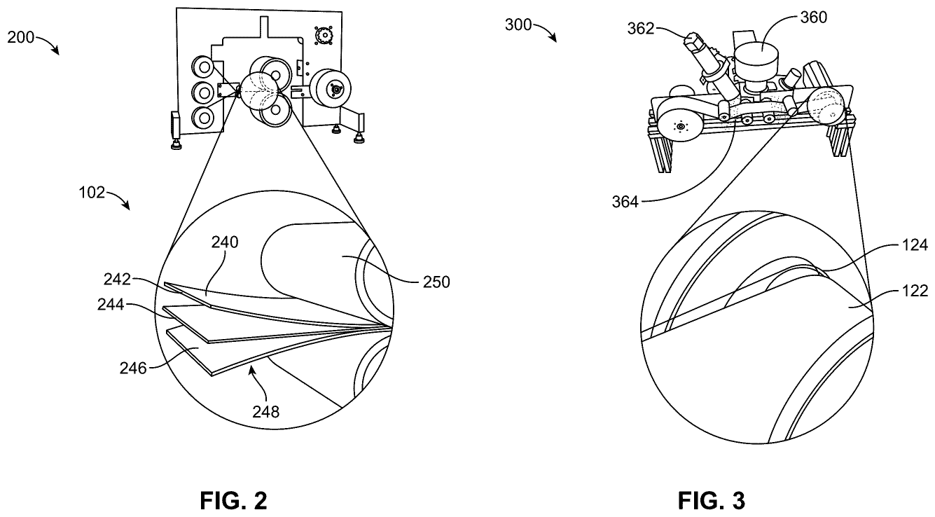

FIG. 2 shows a schematic of a method and a product made by the method according to some embodiments of the present disclosure. For example, FIG. 2 shows a lamination system 200 according to some embodiments. For example, lamination system 200 can laminate battery material films 102. In some aspects, lamination system 200 comprises an anode current collector 240, an anode film 242, a separator 244, a cathode film 246, a cathode current collector 248, and heated rollers 250.

In some aspects, battery material films 102 (FIG. 1) can be fed through heated rollers 250 that press and heat battery material films 102 to provide battery stack film 122.

In some aspects, anode film 242 can be coated onto anode current collector 248 (e.g., a copper film or a copper foil) before laminating. In some aspects, cathode film 246 can be coated onto cathode current collector 248 (e.g., an aluminum film or an aluminum foil) before laminating. In some aspects, the current collector comprises an elastic substrate (e.g., a substrate that can be deformed and return to its original shape) or a plastic substrate (e.g., a substrate that can be deformed and remain in its deformed state). For example, the current collectors can be flexible polymers coated with a copper or aluminum layer, or a cloth substrate coated with a metal film.

In some aspects, separator 244 can be an extruded polymer film (e.g., polyethylene (PE), polypropylene (PP), or combinations thereof (PE/PP)).

FIG. 3 shows a schematic of a method and a product made by the method according to some embodiments of the present disclosure. For example, FIG. 3 shows a laser cutting system 300 according to some embodiments. For example, laser cutting system 300 can be used in fabrication line 100. In some aspects, laser cutting system 300 can comprise a laser source 360, a camera 362, and a backlight source 364.

In some aspects, laser cutting system 300 can remove a portion of battery stack film 122. The removed portion can be battery stack fiber 124 having a width of up to about 1 μm (e.g., from about 0.1 μm to about 0.99 μm, from about 0.2 μm to about 0.9 μm, from about 0.25 μm to about 0.75 μm, from about 0.1 μm to about 1 μm, or from about 0.4 μm to about 1 μm).

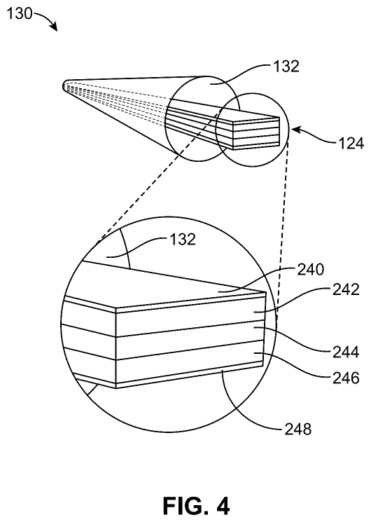

FIG. 4 shows a schematic of a product 130 according to some embodiments of the present disclosure. For example, FIG. 4 shows a close-up planar view of fiber battery 130 according to some embodiments. For example, FIG. 4 shows battery stack fiber 124 and polymer coating 132. In some aspects, and also referring to FIG. 2, fiber battery 130 comprises anode current collector 240 (e.g., copper foil), anode film 242, separator 244, cathode film 246, and cathode current collector 248 (e.g., aluminum foil).

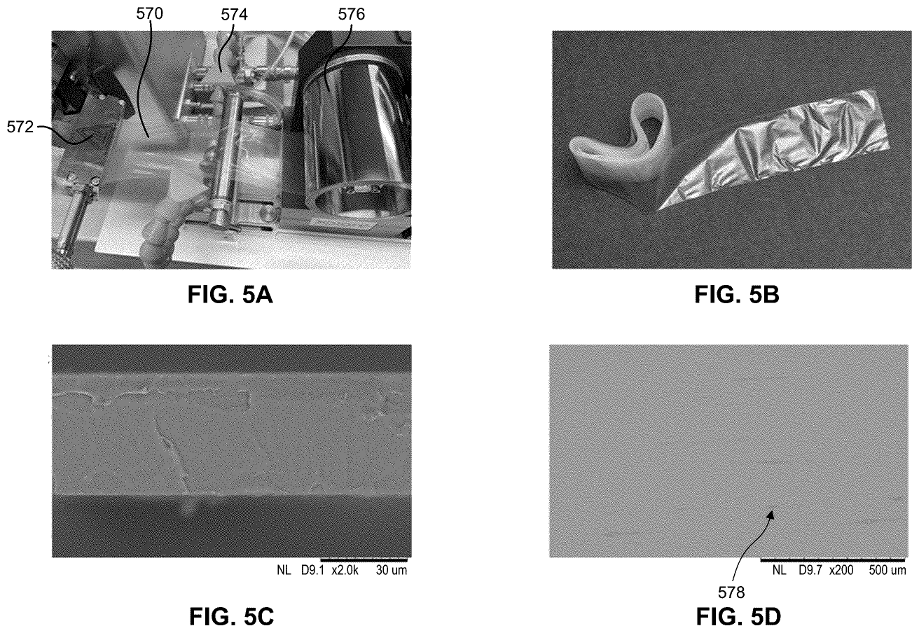

FIGS. 5A-5D show methods and products for providing a polymer separator according to some embodiments of the present disclosure.

FIG. 5A shows an extrusion system 500 according to some embodiments. For example, separating system 500 can comprise film 570 (e.g., an extruded polymer separator film), an extruder nozzle 572, air nozzles 574, and a rewind roller 576.

In some aspects, film 570 can comprise a poly(vinylidene fluoride-co-hexafluoropropylene) (PVDF-HFP) that is extruded into a continuous film having a tailorable thickness. For example, the thickness of extruded polymer separator film 570 can range from about 5 μm to about 100 μm (e.g., from about 10 μm to about 100 μm, from about 20 μm to about 50 μm, from about 5 μm to about 50 μm, or from about 10 μm to about 75 μm).

In some embodiments, the thickness of extruded polymer separator film 570 can be tailored by controlling a speed of feed screws (not shown), a speed of idler rollerers (not shown), and/or a torque of rewind rollerer 576.

In some aspects, extruded polymer separator film 570 exits extruder nozzle 572, is cooled by forced air from air nozzles 574 adjacent to film 570 (e.g., either above and underneath, on either side, or any combination thereof), and is wound onto rewind rollerer 576.

FIG. 5B is a digital image of an extruded polymer separator film 570 according to some embodiments.

FIG. 5C shows a cross-sectional scanning electron microscopy (SEM) image illustrating an extremely dense extruded film 570 according to some embodiments.

FIG. 5D shows a top-down SEM image showing small stretched pores 578 in an extrusion direction according to some embodiments. For example, the extrusion process is capable of producing films with thicknesses as low as 10 μm or as high as hundreds of μm.

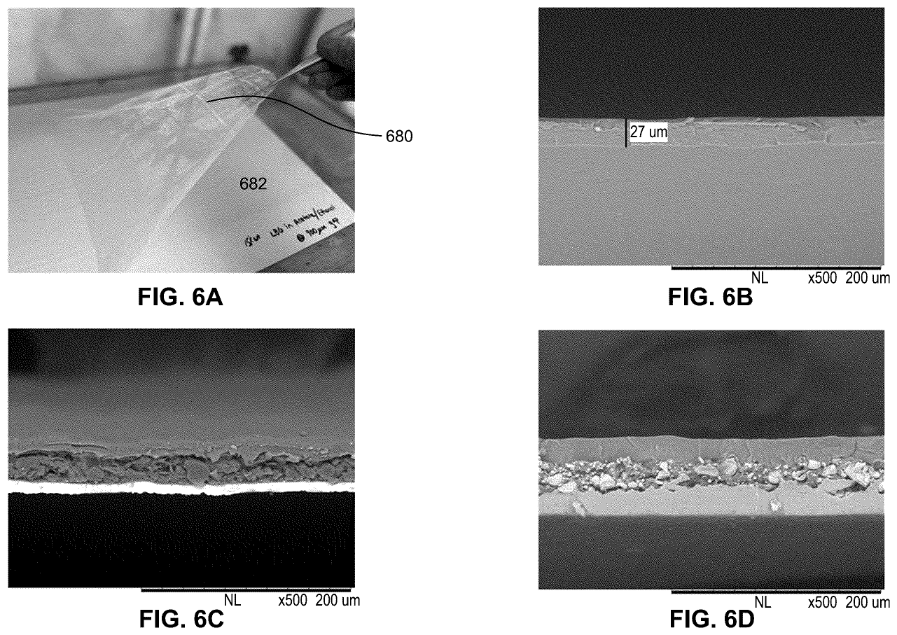

FIGS. 6A-6D show properties of a polymer separator according to some embodiments of the present disclosure. In some embodiments, a polymer separator can utilize a solvent casting process.

FIG. 6A shows a film 680 according to some embodiments. For example, film 680 can be PVDF-HFP film (e.g., either of grades 2800 and Lithium Battery Grade (LBG) PVDF-HFP) solvent-cast on a release liner 682 to provide a dense freestanding film 680.

FIG. 6B shows a cross-sectional SEM images of a freestanding solvent-cast PVDF-HFP LBG film according to some embodiments.

FIG. 6C shows a cross-sectional SEM image of a PVDF-HFP LBG film coated on graphite.

FIG. 6D shows a PVDF-HFP LBG film coated on lithium cobalt oxide (LCO) according to some embodiments.

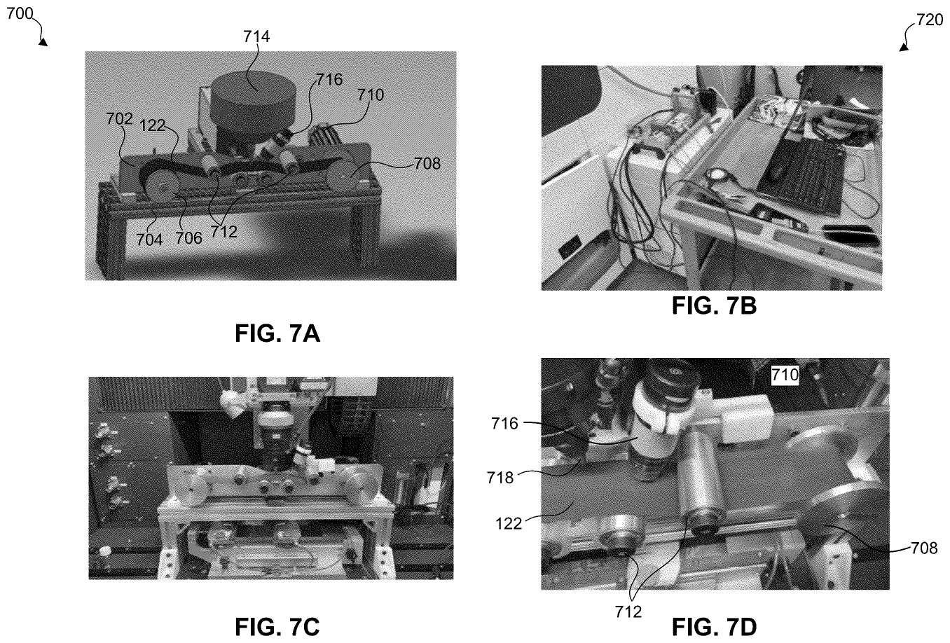

FIGS. 7A to 7D show a roll-to-roll laser cutting system 700 according to some embodiments of the present disclosure.

FIG. 7A shows a roll-to-toll laser cutting system 700 according to some embodiments. For example, roll-to-roll laser cutting system 700 can comprise a mounting plate 702, a base structure 704, a feed roller 706, a rewind roller 708, a rewind roller motor 710, tensioning rollers 712, a laser 714, and a camera 716.

In some embodiments, mounting plate 702 can be supported by base structure 704. Mounting plate 702 can be configured to support feed roller 706 and a feed roller motor (not shown) on an opposite side of mounting plate 702. Mounting plate 702 can also support rewind roller 708 and rewind roller motor 710. Mounting plate 702 can be configured to support a laser 714 and a camera 716 configured to monitor the cutting operation.

In some aspects, tensioning rollers 712 can be mounted to mounting plate 702 to maintain tension in battery stack film 122 (FIG. 1) for the cutting operation.

In some embodiments, camera 716 can include a field of view that captures an entire width of battery stack film 122. The field of view can be calibrated to account for up to about 2 mm of lateral battery stack film 122 movement during the roll-to-roll operation (e.g., lateral movement that is parallel to the rotational axis of rollers 706, 708, 712).

FIG. 7B is a digital image of a control system 720 for operating laser cutting according to some embodiments. In some embodiments, control system 720 can include a feedback control for optimum laser cutting, for example, maintaining a cut removing up to 1 mm from battery stack film 122 (FIG. 1) to provide battery stack fiber 124. In some embodiments, feedback control can maintain a cut with up to a 5% tolerance. For example, the feedback control can maintain a 600 μm cut within ±25 μm.

FIGS. 7C and 7D are digital images showing a roll-to-roll cutting apparatus according to some embodiments. FIG. 7C is a front face view and FIG. 7D is an overhead view showing a laser tip 718 of laser 714, camera 716, tensioning rollers 712, and rewind roller 708 (with rewind roller motor 710).

In some embodiments, a closed-loop feedback system, including camera 716 and software loaded into a control system 720, can control a width of a cut portion removed from battery stack film 122. Control system 720 can be configured to maintain a position of an edge of battery stack film 122 relative to laser 714.

In some embodiments, camera 716 mounted upstream of laser 714 was used to track the edge of battery stack film 122 for a closed-loop feedback system.

In some embodiments, backlight 364 (FIG. 3) can provide contrast for camera 716 to communicate image data to control system 720. In some aspects, backlight 364 can highlight the edge of battery stack film 122. A machine vision program can be configured to receive color images from camera 716 (FIG. 7A). In some examples, the machine vision program can process the images relative to the edge of battery stack film 122, and output a single value indicating the position of the edge of battery stack film 122 within the image.

In some embodiments, the feedback system (e.g., camera 716 and control system 720) can compare the single value to the initial position of the edge of battery stack film 122 and determine positional error (e.g., battery stack film 122 lateral movement described previously).

In some embodiments, the feedback system (e.g., camera 716 and control system 720) can include a proportional control system configured to communicate with a linear actuator (not shown) to move laser tip 718 relative to battery stack film 122 (FIG. 7D) based on the positional error.

In some embodiments, the linear actuator (not shown) can be tuned to a weight of roll-to-roll laser cutting system 700 and can be optimized for rapid response time.

In some embodiments, the laser cutting operation can be performed at a speed ranging from about 50 mm/min to about 500 mm/min (e.g., a 2.4-m-long battery stack fiber 115 can be provided in about 8 min).

In some embodiments, in the example of FIG. 7A, battery stack film 122 was laminated by feeding a graphite-coated copper foil (e.g., the anode including anode current collector 240 and anode film 242, FIG. 2), separator 244 (FIG. 2), and a LCO-coated aluminum foil (e.g., the cathode including cathode current collector 248 and cathode film 246, FIG. 2) through heated rollers 250 heated to 110° C. having a gap between heated rollers 250 that can be about 50 μm thinner than the thickness of anode 240/242, separator 244, and cathode 246/248 combined (e.g., if anode 240/242, separator 244, and cathode 246/248 combined thickness is 250 μm, the gap between heated rollers 250 can be 200 μm). In some aspects, the laser cutting was performed using a nanosecond laser operating at 15 mJ per pulse at a 1-2 kHz repetition rate.

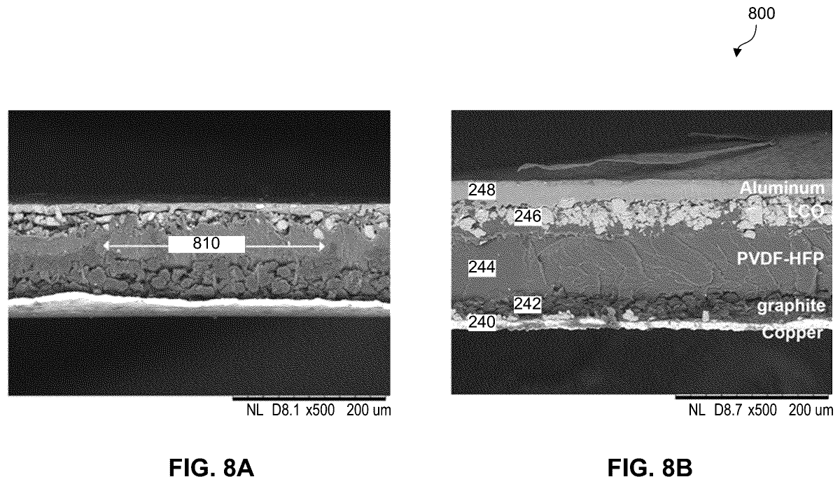

FIGS. 8A to 8B show cross sections of a fiber battery 800 according to some embodiments of the present disclosure. For example, the SEM images show the effect of laminating parameters on delamination and device failure.

In the example of FIG. 8A, graphite tendrils 810 extended into separator layer 244 during electrochemical testing, resulting in a short-circuited device.

In the example of FIG. 8B, battery stack film 122 (FIG. 1) was laminated, as shown in FIG. 2, by feeding a graphite-coated copper foil (e.g., anode 240/242), separator 244, and a LCO-coated aluminum foil (e.g., cathode 246/248) through heated rollers 250 heated to 110° C. having a gap between heated rollers 250 of about 100 μm thinner than the thickness of anode 240/242, separator 244, and cathode 246/248 combined (e.g., if anode 240/242, separator 244, and cathode 246/248 have a combined thickness of 250 μm, the gap between heated rollers 250 can be about 150 μm).

In some embodiments, the laminating condition provided a robust battery stack film 122 and/or battery stack fiber 124 that can survive both the laser cutting operation and electrochemical testing.

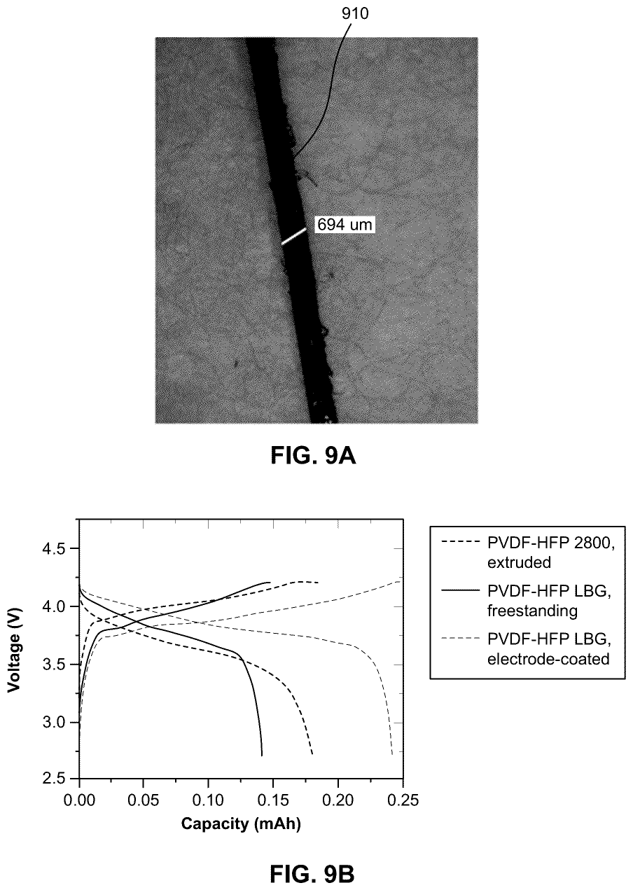

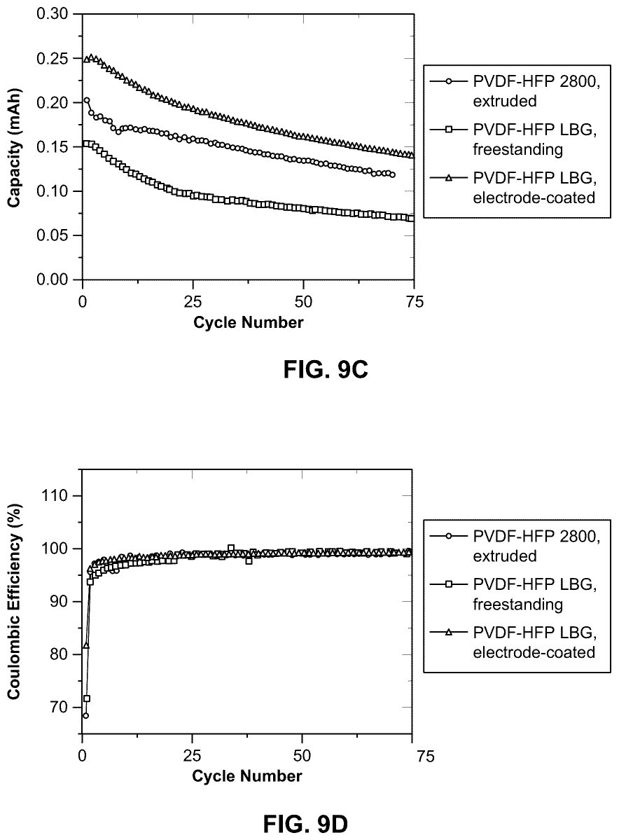

FIGS. 9A to 9D show electrochemical test results according to some embodiments. For example, these figures show electrochemical testing of battery stack fibers 124.

In some aspects, FIG. 9A shows a 700-μm-wide battery stack fiber 910 produced according to some embodiments. For example, battery stack fiber 910 can include an extruded PVDF-HFP 2800 as separator 570 (FIG. 5), 75:25 acetone: ethanol-cast freestanding PVDF-HFP LBG as separator 680 (FIG. 6), and/or dimethylformamide (DMF)-cast electrode-coated PVDF-HFP LBG as the separator (not shown).

In some aspects, battery stack fiber 124, having a width of about 700 μm and a length of about 50 mm were placed into pouch cells (not shown) to test their charge-discharge cycling capability at a 0.1 C-rate.

In some aspects, FIGS. 9B to 9D show electochemcial testing (e.g., charge-discharge cycling) of battery stack fibers according to some embodiments. For example, a DMF-cast electrode-coated PVDF-HFP LBG battery stack fiber (not shown) (referred to as “electrode-coated” in FIGS. 9B to 9D) had a higher initial discharge capacity than battery stack fiber 910 having extruded PVDF-HFP 2800 separator 244 (FIG. 2, referred to as “extruded” in FIGS. 9B to 9D), and the battery stack fiber (not shown) having the 75:25 acetone: ethanol-cast freestanding PVDF-HFP LBG separator 680 (FIG. 6, referred to as “freestanding” in FIGS. 9B to 9D). The electrode-coated sample battery stack fiber exhibited an average voltage of 3.8 V, the extruded sample battery stack fiber 910 exhibited an average voltage of 3.63 V, and the freestanding sample battery stack fiber exhibited an average voltage of 3.77 V.

In some aspects, FIG. 9C shows charge capacity retention after a period of 45 charge-discharge cycles. For example, after 45 cycles the electrode-coated sample battery stack fiber retained 67% of its initial capacity, the freestanding sample battery stack fiber retained 54% of its initial capacity, and the extruded sample battery stack fiber 910 retained 69% of its initial capacity.

In some embodiments, FIG. 9D shows the Coulombic efficiency vs. cycle number for the same pouch cells. For example, the electrode-coated sample battery stack fiber, the freestanding sample battery stack fiber, and the extruded sample battery stack fiber 910 each exhibited close to 100% Coulombic efficiency after continued charge-discharge cycling.

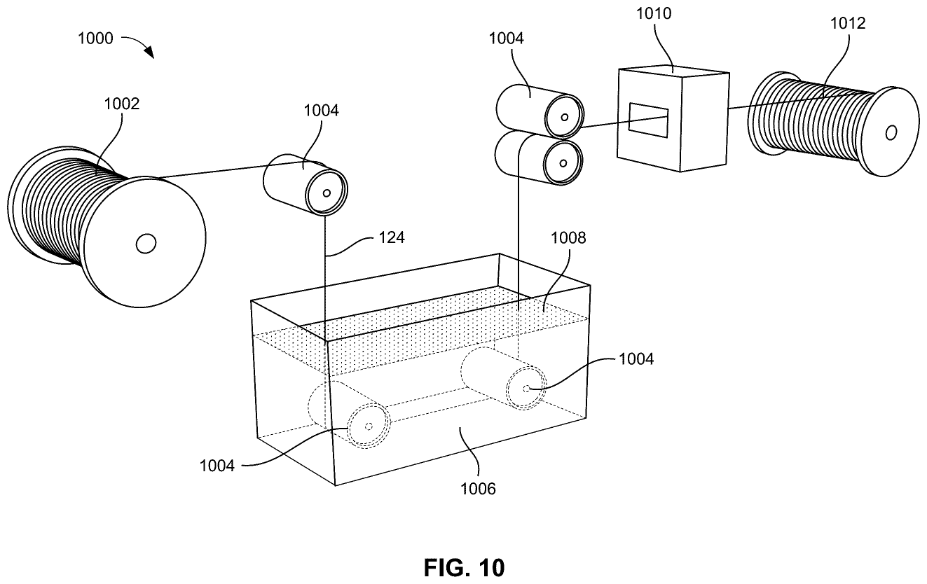

FIG. 10 shows a coating station 1000 according to some embodiments. In some aspects, coating station 1000 can comprise a feed roller 1002, tensioning rollers 1004, bath 1006 configured to hold a coating solution 1008, curing device 1010, and a rewind roller 1012. In some embodiments, coating station 1000 can be included in fabrication line 100 as shown in FIG. 1.

In some aspects, battery stack fiber 124 can be fed into coating station 1000 either by feed roller 1002 or by incorporation into fabrication line 100 (FIG. 1). Tensioning rollers 1004 can maintain tension in battery stack fiber 124 such that coating station 1000 can provide a uniform polymer coating 132 (FIG. 1). Battery stack fiber 124 coated with coating solution 1008 can then be fed into curing device 1010 to provide a uniform, solid, and flexible polymer coating 132 encasing battery stack fiber 124, thus providing fiber battery 130 (FIG. 1). Fiber battery 130 can be wound onto rewind roller 1012.

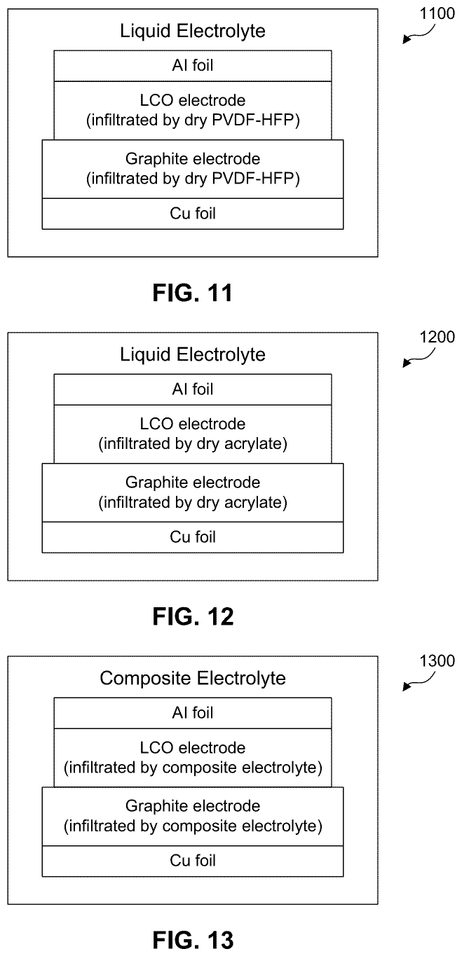

FIGS. 11-13 show various embodiments of battery stack film 122.

In some aspects, FIG. 11 shows a battery stack 1100 according to some embodiments. For example, battery stack 1100 can include a liquid electrolyte (not shown), and battery stack 1100 may not need a separator. In some aspects, a graphite anode coated onto a copper foil current collector (e.g., anode 240/242) can be laminated to a LCO cathode coated onto an aluminum foil current collector (e.g., cathode 246/248). The laminated anode 240/242 and cathode 246/248 can be immersed in an electrolyte solution in a roll-to-roll procedure as described above in the example of the coating operation (FIG. 10).

In some aspects, FIG. 11 shows a PVDF-HFP-impregnated battery stack 1100 having a fused polymer separator coated onto anode 240/242 and cathode 246/248.

FIG. 12 shows a battery stack 1200, according to some embodiments. For example, FIG. 12 shows battery stack 1200 having a dry acrylate material. In some aspects, anode 240/242 and cathode 246/248 can be immersed in a liquid acrylate precursor solution such that the acrylate precursor solution impregnates anode 240/242 and cathode 246/248. In some aspects, the acrylate precursor solution is cured (i.e., polymerized) using thermal, electromagnetic, or physical stimulation, providing battery stack 1200 having a cross-linked polymer separator (not shown).

FIG. 13 shows a battery stack 1300 according to some embodiments. For example, battery stack 1300 can have a fused solid polymer and/or ceramic composite electrolyte (not shown). In some aspects, anode 240/242 and cathode 246/248 can be impregnated with a composite electrolyte having sufficient properties to provide a functional battery device without a freestanding polymer separator interposed between anode 240/242 and cathode 246/248.

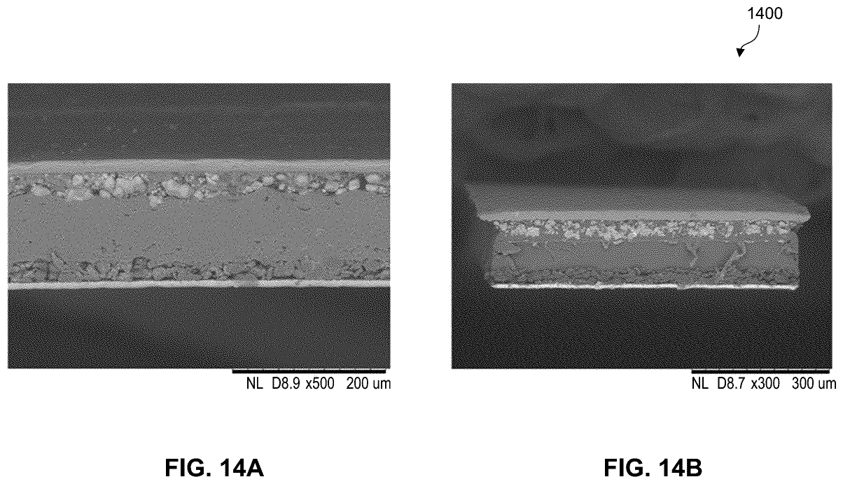

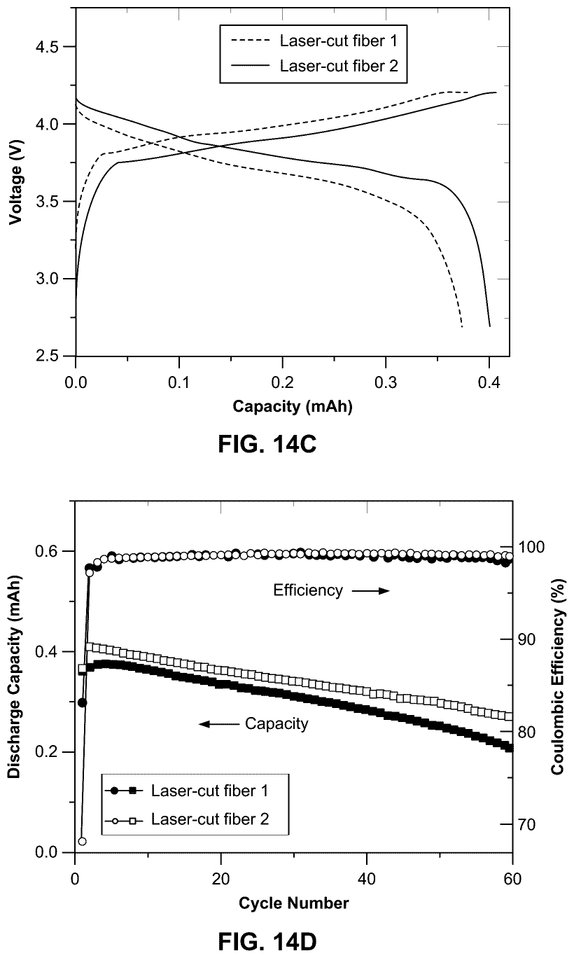

FIGS. 14A to 14D show cross-sectional SEM analysis and electrochemical testing of battery stack fibers 124 cut using a picosecond laser according to some embodiments.

In some aspects, FIGS. 14A-14B show SEM images of a laser-cut edge 1400 having a smooth interface with less evidence of polymer melting compared to samples cut with a nanosecond laser (FIG. 8).

FIGS. 14C and 14D show electrochemical test results according to some embodiments.

In some examples, Electrochemical testing was performed by cutting sections of 74 mm and 83 mm in length from a picosecond laser-cut 700-μm-wide battery stack fiber 124 and tested in pouch cells.

In some aspects, FIG. 14C shows at cycle 5 the samples had average voltages of 3.7-3.78 V, achieved 74-83% of their calculated expected capacity, and exhibited linear capacities of 0.05 mAh cm⁻¹ and linear energies of 0.18-0.19 mWh cm⁻¹.

In some aspects, FIG. 14D shows that after 60 cycles at a charge-discharge rate of 0.1 C, the samples retained 55-66% of their initial capacities.

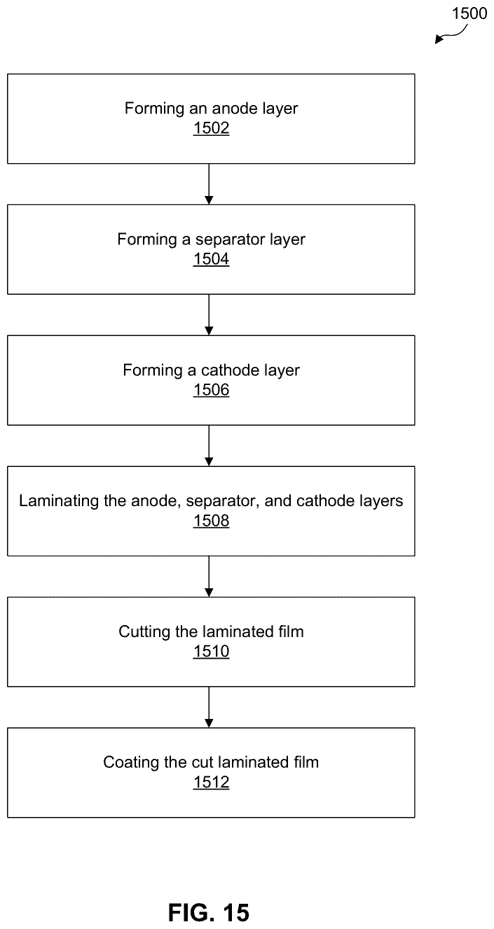

FIG. 15 depicts a method 1500 according to some embodiments. For example, method 1500 can be used for making a fiber battery. It is to be appreciated that not all operations need be performed or performed in the order shown. In one example, the operations shown relate to FIG. 1 to FIG. 4.

In one aspect, operation 1502 forms an anode layer that can include coating anode current collector 240 with anode film 242 (FIG. 2). For example, anode film 242 can be graphite, and anode current collector 240 can be a copper foil.

In one aspect, operation 1504 forms a separator layer that can include extruding polymer film 570 in a hot melt extrusion process (FIG. 5).

In one aspect, operation 1506 an operation forms a cathode layer that can include coating cathode current collector 248 with cathode film 246. For example, cathode film 246 material can be LCO and cathode current collector 248 can be an aluminum foil and/or an aluminum alloy foil (FIG. 2).

In one aspect, operations 1502, 1504, and 1506 can be performed in a series of any combination, concomitantly, or in any order.

In one aspect, operation 1508, after forming the anode layer, the separator layer and the cathode layer, laminates the anode layer, the separator layer, and the cathode layer to provide a laminated film (e.g., to provide battery stack film 122, FIG. 1/FIG. 2). In one aspect, operation 1510 removes a linear portion of battery stack film 122. In one aspect, removing a portion of battery stack film 122 can provide battery stack fiber 124 (e.g., by laser cutting a portion having a width of up to 1 mm as described above, FIG. 1).

In one aspect, operation 1512 coats battery stack fiber 124 to provide fiber battery 130 (e.g., by immersing battery stack fiber 124 in coating solution 1008 (FIG. 10) and curing coating solution 1008 in curing device 1010 (FIG. 10).

In some embodiments, method 1500 includes immersing battery stack fiber 124 in an electrolyte solution (not shown) before coating operation 1512 (e.g., immersing battery stack fiber 124 in an electrolyte solution that is immiscible with coating solution 1008). In some embodiments, laminating operation 1508, removing operation 1510, and coating operation 1512 are performed in a roll-to-roll process as depicted in the example of FIG. 1.

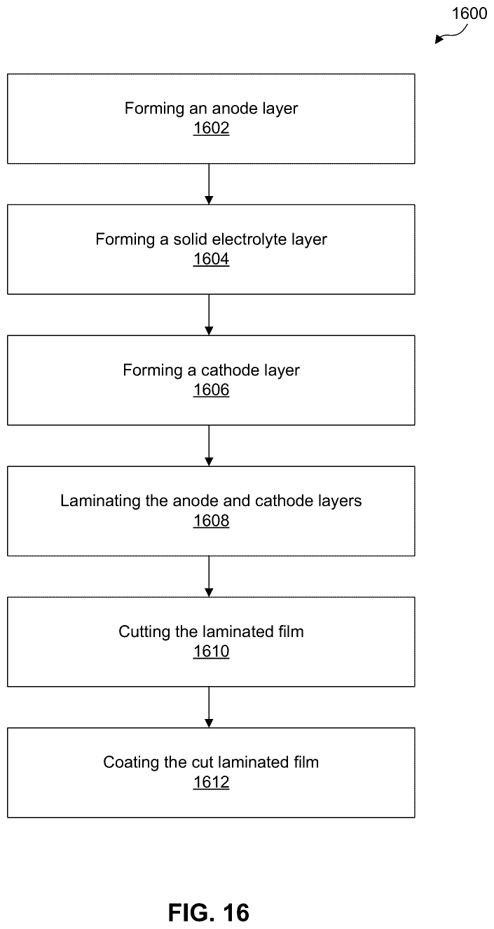

FIG. 16 depicts a method 1600 according to some embodiments. For example, method 1600 can be used for making a fiber battery. It is to be appreciated that not all operations need be performed or performed in the order shown. In one example, the operations shown relate to FIG. 1 to FIG. 4.

In one aspect, operation 1602 forms an anode layer that can include coating an anode current collector 240 with an anode film 242 (FIG. 2). For example, anode film 242 can be graphite, and anode current collector 240 can be a copper foil.

In one aspect, operation 1604 forms a solid electrolyte layer that can include impregnating and fusing a solid polymer and/or ceramic composite electrolyte into either or both of anode film 242 and cathode film 246 (FIGS. 2, 13).

In one aspect, operation 1606 forms a cathode layer that can include coating a cathode current collector 248 with a cathode film 246. For example, cathode film 246 material can be LCO and cathode current collector 248 can be an aluminum foil and/or an aluminum alloy foil (FIG. 2).

In one aspect, operations 1602, 1604, and 1606 can be performed in a series of any combination, concomitantly, or in any order.

In one aspect, operation 1608 forms a battery stack film 122 by impregnating anode film 242 and cathode film 246 with a solid polymer and/or ceramic composite electrolyte and laminating the anode layer and the cathode layer (e.g., to provide battery stack film 122, FIG. 2).

In other aspects, operation 1608 forms the solid electrolyte film by mixing a solid electrolyte material with an anode material, a cathode material, or an anode material and a cathode material prior to laminating.

In one aspect, operation 1612 can include removing a linear portion of battery stack film 122. In one aspect, removing a portion of battery stack film 122 can provide a battery stack fiber 124 (e.g., by laser cutting a portion having a width of up to 1 mm as described above, FIG. 1).

In one aspect, operation 1614 coats battery stack fiber 124 to provide fiber battery 130 (e.g., by immersing battery stack fiber 124 in coating solution 1008 and curing coating solution 1008, FIG. 10).

In some embodiments, method 1600 can include immersing battery stack fiber 124 in an electrolyte solution before coating operation 1610 (e.g., immersing battery stack fiber 124 in an electrolyte solution that is immiscible with coating solution 1008). In some embodiments, laminating operation 1608, removing operation 1610, and coating operation 1612 are performed in a roll-to-roll process as depicted in the example of FIG. 1.

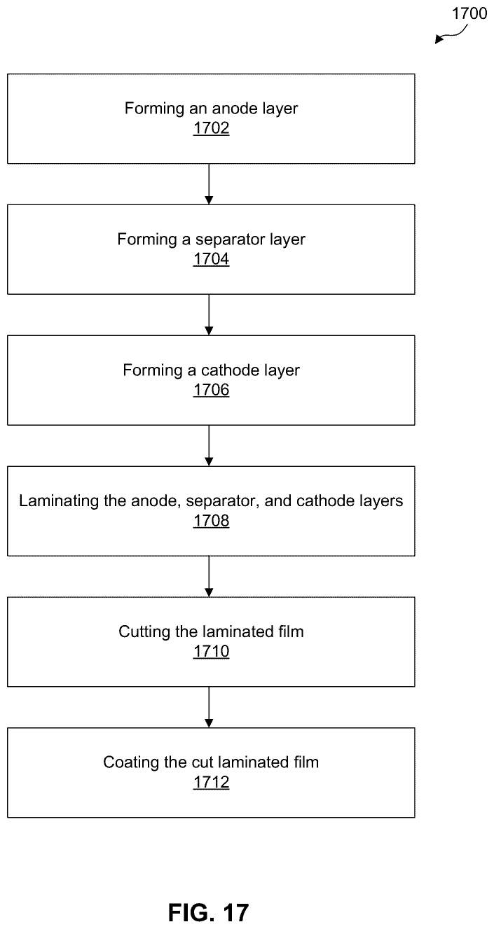

FIG. 17 depicts a method 1700 according to some embodiments. For example, method 1700 can be a roll-to-roll process used for making a fiber battery. It is to be appreciated that not all operations need be performed or performed in the order shown. In one example, the operations shown relate to FIG. 1 to FIG. 4.

In one aspect, operation 1710 forms an anode layer that can include coating anode current collector 240 with anode film 242 (FIG. 2) in a roll-to-roll operation. For example, anode film 242 can be graphite, and anode current collector 240 can be a copper foil.

In one aspect, operation 1720 forms a separator film that can include extruding a polymer film 570 (FIG. 5) in a hot melt extrusion process (FIG. 2) and winding polymer film 570 onto a rewind roller 576 (FIG. 5) in a roll-to-roll operation.

In some aspects, operation 1720 forms a solid polymer electrolyte separator film that can include extruding a polymer film 570 (FIG. 5) in a hot melt extrusion process (FIG. 2) and winding polymer film 570 onto a rewind roller 576 (FIG. 5) in a roll-to-roll operation.

In one aspect, operation 1730 forms a cathode layer that can include coating cathode current collector 248 with cathode film 246. For example, cathode film 246 material can be LCO and cathode current collector 248 can be an aluminum foil and/or an aluminum alloy foil (FIG. 2).

In one aspect, operations 1702, 1704, and 1706 can be performed in a series of any combination, concomitantly, or in any order.

In one aspect, operation 1740, after forming the anode layer, the separator layer, and the cathode layer, laminates the anode layer, the separator layer, and the cathode layer (e.g., to provide battery stack film 122, FIG. 2).

In one aspect, operation 1750 removes a linear portion of battery stack film 122. In one aspect, removing a portion of battery stack film 122 can provide battery stack fiber 124 (e.g., by laser cutting a portion having a width of up to 1 mm as described above, FIG. 1/FIG. 7).

In one aspect, operation 1760 coats battery stack fiber 124 to provide fiber battery 130 (e.g., by immersing battery stack fiber 124 in a coating solution 1008 and curing coating solution 1008 in curing device 1010, FIG. 10).

In some embodiments, method 1700 includes immersing battery stack fiber 124 in an electrolyte solution before coating operation 1712 (e.g., immersing battery stack fiber 124 in an electrolyte solution that is immiscible with coating solution 1008, FIG. 10). In some embodiments, laminating operation 1708, removing operation 1710, and coating operation 1712 are performed in a roll-to-roll process as depicted in the example of FIG. 1.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A fiber battery, comprising:
an anode film;
a cathode film;
a separator film disposed between the anode film and the cathode film, wherein the anode film, the cathode film, and the separator film comprise a fiber battery stack having a width of up to 1 millimeter (mm); and
a coating configured to cover the fiber battery stack.

2. The fiber battery of claim 1, wherein the anode film and the cathode film further comprise a current collector.

3. The fiber battery of claim 2, wherein the anode film current collector comprises copper and the cathode film current collector comprises aluminum.

4. The fiber battery of claim 2, wherein the current collector comprises an elastic substrate or a plastic substrate.

5. The fiber battery of claim 1, further comprising a battery stack film configured to be cut to provide the fiber battery stack.

6. The fiber battery of claim 1, wherein the coating is amenable to use in a fabric.

7. A method of making a fiber battery, comprising:
forming an anode film;
forming a separator film;
forming a cathode film;
laminating the anode film, the separator film, and the cathode film to provide a battery stack film;
removing a linear portion of the battery stack film to provide a battery stack fiber; and
coating the battery stack fiber to provide the fiber battery.

8. The method of claim 7, wherein the removing the linear portion of the battery stack film comprises laser cutting the battery stack film.

9. The method of claim 7, wherein the removing the linear portion of the battery stack film comprises removing a portion having a width of up to 1 mm.

10. The method of claim 7, wherein the coating comprises immersing the battery stack fiber in a liquid coating solution.

11. The method of claim 10, wherein the coating further comprises curing the liquid coating solution.

12. The method of claim 11, further comprising immersing the battery stack fiber in an electrolyte solution before the coating.

13. The method of claim 12, wherein immersing the battery stack fiber in the electrolyte solution comprises immersing the battery stack fiber in an electrolyte solution that is immiscible with the liquid coating solution.

14. The method of claim 7, wherein the laminating, the removing, and the coating are performed in a roll-to-roll process.

15. The method of claim 7, wherein the forming the separator film comprises extruding a polymer film.

16. A method of making a fiber battery, comprising:
forming an anode film;
forming a solid electrolyte film;
forming a cathode film;
laminating the solid electrolyte film and the cathode film to provide an electrolytic cathode film;
laminating the anode film and the electrolytic cathode film to provide a battery stack film;
removing a linear portion of the battery stack film to provide a battery stack fiber; and
coating the battery stack fiber to provide the fiber battery.

17. The method of claim 16, wherein the removing the linear portion of the battery stack film comprises laser cutting the battery stack film.

18. The method of claim 16, wherein the removing the linear portion of the battery stack film comprises removing a portion having a width of up to 1 mm.

19. The method of claim 16, wherein the coating comprises immersing the battery stack fiber in a liquid coating solution.

20. The method of claim 19, wherein the coating further comprises curing the liquid coating solution.

21. The method of claim 16, wherein the laminating, the removing, and the coating are performed in a roll-to-roll process.

22. The method of claim 16, wherein the forming the solid electrolyte film comprises mixing a solid electrolyte material with an anode material, a cathode material, or an anode material and a cathode material.

23. A method of providing a fiber battery, comprising:
a roll-to-roll process, comprising:
coating a first current collector with a first electrode material;
coating a second current collector with a second electrode material;
extruding a separator film;
laminating the first current collector having the first electrode material, the separator film, and the second current collector having the second electrode material to provide a battery stack film;
laser cutting a portion of the battery stack film to provide a battery stack fiber; and
encapsulating the battery stack fiber.

24. The method of providing a fiber battery of claim 23, wherein the coating the first current collector with the first electrode material comprises coating a copper film with an anodic electrode material to provide an anode film.

25. The method of providing a fiber battery of claim 23, wherein the coating the second current collector with the second electrode material comprises coating an aluminum film with a cathodic electrode material to provide a cathode film.

26. The method of providing a fiber battery of claim 23, wherein the laminating comprises feeding the first current collector having the first electrode material, the separator film, and the second current collector having the second electrode material through a thermal roller press.

27. The method of providing a fiber battery of claim 23, further comprising mixing a solid electrolyte material with an anode material, a cathode material, or an anode material and a cathode material prior to the laminating.

28. The method of providing a fiber battery of claim 23, wherein the laser cutting comprises:
activating a laser;
aiming the laser at the battery stack film;
illuminating the battery stack film on a first side of the battery stack film with a white light source;
observing the laser cutting operation with a camera disposed on a side of the battery stack film opposite the white light source; and
controlling the laser cutting operation with a control unit configured to interpret data received from the camera, wherein the controlling the laser cutting comprises maintaining cutting a portion of the battery stack film having a width of up to 1 mm.

29. The method of providing a fiber battery of claim 23, wherein the encapsulating the battery stack fiber comprises immersing the battery stack fiber in a liquid polymer solution.

30. The method of providing a fiber battery of claim 29, further comprising curing the liquid polymer solution to provide a solid polymer coating.

31. A roll-to-roll fiber battery fabrication fixture, comprising:
a feed roller configured to supply a battery stack component film, wherein the battery stack component film comprises an anode film, a separator film, and a cathode film;
a laminating roller configured to press and thermally laminate the battery stack component films into a battery stack film;
a tensioning roller configured to reduce film vibration during roll-to-roll processing;
a laser cutter configured to remove a portion of the battery stack film to provide a battery stack fiber;
a camera configured to observe the laser cutter and generate camera information;
a back light configured to provide reference lighting for the camera;
a control unit configured to receive the camera information and adjust the laser cutter to maintain a consistent width of the portion of the battery stack film being removed; and
a rewind roller configured to collect the battery stack fiber after roll-to-roll fabrication.

32. The roll-to-roll fiber battery fabrication fixture of claim 31, further comprising a roll-to-roll coating fixture.

33. The roll-to-roll fiber battery fabrication fixture of claim 31, further comprising a battery stack fiber rewind roller.

34. The roll-to-roll fiber battery fabrication fixture of claim 33, further comprising a plurality of laser cutters.

35. The roll-to-roll fiber battery fabrication fixture of claim 33, further comprising a plurality of battery stack fiber rewind rollers.

36. The roll-to-roll fiber battery fabrication fixture of claim 31, further comprising a coating station configured to immerse the battery stack fiber in a polymer solution and cure the polymer solution to provide a fiber coating.
